(19) United States
(12) Patent Application Publication
(10) Pub. No.: US 2016/0186034 A1
(43) Pub. Date: Jun. 30, 2016

(54) SYNERGISTIC ORGANOPHILIC CLAY MIXTURE AS AN ADDITIVE TO OIL-BASED DRILLING FLUIDS

(71) Applicant: BAKER HUGHES INCORPORATED, Houston, TX (US)

(72) Inventors: WILSON MAINYE, Fresno, TX (US); MICHAEL BRIAN TEUTSCH, Houston, TX (US)

(73) Assignee: BAKER HUGHES INCORPORATED, Houston, TX (US)

(21) Appl. No.: 14/911,156

(22) PCT Filed: Mar. 10, 2015
(86) PCT No.: PCT/US2015/019634

§ 371 Date: Feb. 9, 2016

Related U.S. Application Data
(60) Provisional application No. 61/951,098, filed on Mar. 11, 2014.

(51) Int. Cl. C09K 8/32; C09K 8/03

(52) U.S. Cl. CPC C09K 8/32; C09K 8/032

(57) ABSTRACT

An organophilic clay mixture having a first organophilic clay that is modified attapulgite clay and/or modified sepiolite clay, together with an organophilic modified bentonite clay, may be used as a rheological additive to improve the ultra-low shear rate viscosity of oil-based or synthetic oil-based drilling fluids (O/SBMs) and to increase the carrying capacity of the oil mud, while reducing the high shear rate readings. The clays are modified by treating them with quaternary amines and/or quaternary ammonium salts. The organophilic clay mixture significantly yields stable gels that are non-progressive compared to each individual organophilic clay used separately.

### TECHNICAL FIELD

The present invention relates to methods and compositions for formulating oil-based or synthetic oil-based drilling fluids or muds (O/SBMs), and more particularly relates, in one non-limiting embodiment, to clay compositions and methods of using them for improving ultra-low shear rate viscosity of O/SBMs, increasing the carrying capacity of the O/SBMs, and/or reducing the high shear rate readings of the O/SBMs.

### TECHNICAL BACKGROUND

Drilling fluids used in the drilling of subterranean oil and gas wells along with other drilling fluid applications and drilling procedures are well known. In rotary drilling there are a variety of functions and characteristics that are expected of drilling fluids, also known as drilling muds, or simply “muds”.

Drilling fluids are typically classified according to their base fluid. In water-based muds, solid particles are suspended in water or brine. Oil can be emulsified in the water which is the continuous phase. Brine-based drilling fluids, of course are a water-based mud (WBM) in which the aqueous component is brine. Oil-based muds (OBM) are the opposite or inverse. Solid particles are often suspended in oil, and water or brine is emulsified in the oil and therefore the oil is the continuous phase. Oil-based muds can be either all-oil based or water-in-oil macroemulsions, which are also called invert emulsions. In oil-based mud the oil can consist of any oil that may include, but is not limited to, diesel, mineral oil, esters, or alpha-olefins. OBMs as defined herein also include synthetic-based fluids or muds (SBMs) which are synthetically produced rather than refined from naturally-occurring materials. SBMs often include, but are not necessarily limited to, olefin oligomers of ethylene, esters made from vegetable fatty acids and alcohols, ethers and polyethers made from alcohols and polyalcohols, paraffinic, or aromatic hydrocarbons, alkyl benzenes, terpenes and other natural products and mixtures of these types. OBMs and/or SBMs are sometimes collectively referred to as non-aqueous fluids or NAFs.

It is also well known that organophilic days (or “organoclays”) may be used to thicken organic compositions and particularly drilling fluids. Organophilic clay minerals are those whose surfaces have been coated with a chemical to make them oil-dispersible. Bentonite and hectorite (plate-like clays) and attapulgite and sepiolite (rod-shaped days) are treated with oil-wetting agents during manufacturing and may be used as oil mud additives. Quaternary fatty-acid amines may applied to the clay. Amines may be applied to dry clay during grinding or it can be applied to clay dispersed in water. The latter process is more expensive, requiring filtering, drying and other manufacturing steps. Organophilic bentonite and hectorite, “bentones,” may be used in oil muds to build rheology for lifting drill cuttings and solids suspension. They also contribute to low-permeability filter cakes. Organophilic attapulgite and sepiolite are used in oil muds strictly to build gel structure, which may not be long lasting due to shear degradation as the mud is pumped through the bit.

The efficiency of some organophilic clays in non-aqueous systems may be further improved by adding a low molecular weight polar organic material to the composition. Such polar organic materials have been called polar activators, dispersants, dispersion aids, solvating agents and the like.

More specifically, hole cleaning in deviated wells is still a challenge in the oil industry for invert emulsion mud systems. It would be desirable if compositions and methods could be devised to improve ultra-low shear rate viscosity, to increase the carrying capacity of the OBM, and/or also reducing the high shear rate readings of the mud.

### SUMMARY

There is provided in one non-limiting embodiment an organophilic clay mixture that includes a first organophilic clay selected from the group consisting of modified attapulgite clay, modified sepiolite clay and combinations thereof; and an organophilic modified bentonite clay. The clays have been modified by treating them with at least one compound selected from the group consisting of quaternary amines, quaternary ammonium salts, and combinations thereof.

There is additionally provided in one non-restrictive version, an oil-based drilling mud that includes an oil-based drilling fluid base composition and an organophilic clay mixture. Again, the organophilic day mixture includes a first organophilic clay selected from the group consisting of modified attapulgite clay, modified sepiolite clay and combinations thereof; and an organophilic modified bentonite clay. The clays have been modified by treating them with at least one compound selected from the group consisting of quaternary amines, quaternary ammonium salts, and combinations thereof.

There may be further provided a method of drilling a wellbore through a subterranean formation with an oil-based drilling mud where the oil-based drilling mud includes an oil-based drilling fluid base composition and an organophilic clay mixture. Once more, the organophilic clay mixture includes a first organophilic clay selected from the group consisting of modified attapulgite clay, modified sepiolite clay and combinations thereof; and an organophilic modified bentonite clay. The clays have been modified by treating them with at least one compound selected from the group consisting of one quaternary amines, quaternary ammonium salts, and combinations thereof.

### BRIEF DESCRIPTION OF THE DRAWINGS

FIG. 1 is a graph showing a comparison of a high shear rate viscosity reduction at a 600 rpm reading for 100 wt % modified bentonite formulation with four blends of a 10 wt % attapulgite/sepiolite clay blend and modified bentonite clay formulation before aging;

FIG. 2 is a graph showing a comparison of a high shear rate viscosity reduction at a 600 rpm reading for the 100 wt % modified bentonite formulation with the four blends of a 10 wt % attapulgite/sepiolite and modified bentonite clay formulation of FIG. 1 after aging;

FIG. 3 is graph comparing 6 rpm values before and after hot rolling for various blends of attapulgite/sepiolite clays;

FIG. 4 is graph comparing the viscosity of a pure modified bentonite day and a 10 wt % attapulgite/sepiolite clay blend at an ultra-low shear rate of 0.01 1/s;

FIG. 5 is graph comparing the viscosity of a pure modified bentonite day and a 10 wt % attapulgite/sepiolite clay blend at an ultra-low shear rate of 1.76 1/s;

FIG. 6 is graph comparing the viscosity of a pure modified bentonite day and a 10 wt % attapulgite/sepiolite clay blend at an ultra-low shear rate of 31.7 1/s;

FIG. 7 is a graph comparing Brookfield viscometer testing (LSVR) for BENTONE® 910 suspension additive as compared with three inventive blends after aging at 275° F. (135° C.) for 16 hours at 0.1 rpm using spindle #4;

FIG. 8 is a graph comparing Brookfield viscometer testing (LSVR) for BENTONE® 910 suspension additive as compared with three inventive blends after aging at 275° F. (135° C.) for 16 hours at 0.01 rpm using spindle #4;

FIG. 9 is a graph comparing Brookfield viscometer testing (LSVR) for BENTONE® 910 suspension additive as compared with three inventive blends after aging at 275° F. (135° C.) for 16 hours at 0.01 rpm using spindle #4;

FIG. 10 is a graph of the gradual decline of the 600 rpm and 300 rpm readings as MP-HOLD™ cuttings suspension agent displaces the CARBO-GEL® II fluid for a well in north Texas;

FIG. 11 is a graph showing a comparison of the CARBO-GEL® II cuttings suspension fluid rheology profile (at mud report 8) and the MP-HOLD™ fluid rheology (mud report 17) for the north Texas well;

FIG. 12 is a well profile comparing the CARBO-GEL® II fluid with the MP-HOLD™ fluid for decreasing rpms for the north Texas well;

FIG. 13 is a graph comparing the dial readings as a function of rpms for the north Texas well for the CARBO-GEL® II fluid and the MP-HOLD™ fluid at a stand pipe pressure of 2416 psi (16.66 MPa) and a reduced equivalent circulating density of 9.46 ppg (1.13 kg/I); and

FIG. 14 is a graph comparing the decline in gel progressivity for the indicated mud reports for Example 20.

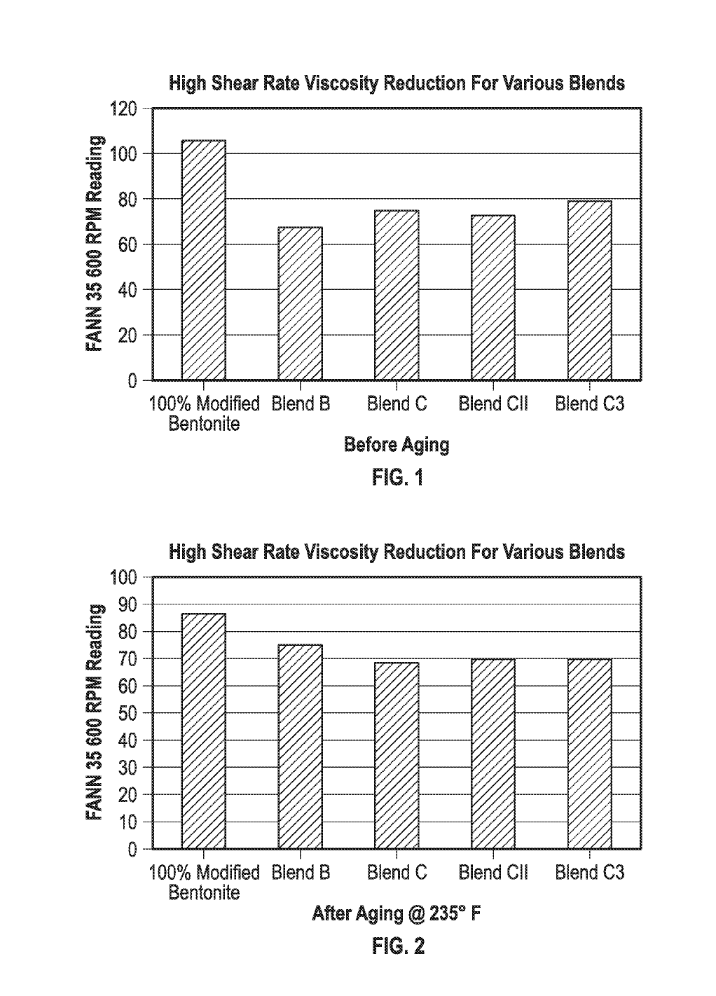

### DETAILED DESCRIPTION

The challenges of hole or wellbore cleaning in deviated wells have resulted in further studies on improving the rheological behavior and viscosity building interactions. It has been surprisingly discovered that mixtures of organophilic clays, discussed herein, provide better hydraulic benefits, with fewer cutting beds being formed, when formulated in oil-based drilling fluids. Cutting bed problems tend to form more readily in the drilling of deviated wells (any well with a significant deviation from the vertical). Cuttings in deviated or horizontal wells, even though carried by drilling fluid away from the bit, tend to settle eventually beneath the drill string in a deviated or horizontal segment Cuttings form what are referred to as “cutting beds” on the lower side of non-rotating drill strings in deviated portions of a wellbore. Buildup of “cutting beds” leads to undesirable friction and possibly to the sticking of the drill string.

These new blends are temperature tolerant up to 275° F. (135° C.), which is typical for US land applications.

Compositions of the blends include mixing a first organophilic clay, which is a modified attapulgite and/or modified sepiolite clay with an organophilic modified bentonite clay at weight ratios of from about 5 wt % independently to about 95 wt % and vice versa, alternatively from about 10 wt % independently to about 90 wt % and vice versa, and in another non-limiting embodiment from about 30 wt % independently to about 70 wt % and vice versa. In most practical applications, an attapulgite range of from about 5 to about 30 wt % is suitable. As used herein with respect to a range, the term “independently” means that any lower threshold may be combined with any upper threshold to form an acceptable alternative range.

Attapulgite is a magnesium aluminum phyllosilicate clay with formula (Mg.Al)₂Si₄O₁₀(OH).4(H₂O). Sepiolite is a complex magnesium silicate clay mineral with a typical formula of Mg₄Si₆O₁₅(OH)₂.6H₂O. It may be present in fibrous, fine-particulate, and solid forms. Bentonite is an absorbent aluminum phyllosilicate, essentially impure clay consisting mostly of montmorillonite.

By “modified” with respect to the clays is meant that the clay mineral is treated with at least one compound including, but not necessarily limited to, a quaternary amine and/or a quaternary ammonium salt, to make it organophilic. Suitable treatment methods and compounds within the meaning of “modified” include, but are not necessarily limited to, those described in U.S. Pat. No. 8,389,447. This patent discloses an additive composition including a synergistic combination of a hectorite organoclay composition and an attapulgite organoclay composition. The hectorite organoclay composition includes (i) a first organic cation provided by an alkoxylated quaternary ammonium salt; and (ii) a second organic cation wherein such second organic cation is not provided by an alkoxylated quaternary ammonium salt. The attapulgite organoclay composition includes (iii) a third organic cation provided by an alkoxylated quaternary ammonium salt; and (iv) a fourth organic cation wherein such third organic cation is not provided by an alkoxylated quaternary ammonium salt.

The '447 patent further discloses an organophilic clay additive for oil based drilling fluids providing such fluid with improved temperature stable rheological properties is disclosed. In one embodiment, the organophilic additive comprises the reaction product of an attapulgite clay having a cation exchange capacity of at least 5 milliequivalents per 100 grams of clay, 100% active clay basis; and a first organic cation provided by an alkoxylated quaternary ammonium salt; and a second organic cation wherein such second organic cation is not provided by an alkoxylated quaternary ammonium salt The total amount of the first and second organic cations is provided in an amount from about +25% to −25% of the cation exchange capacity of the attapulgite clay, preferably from +/−10% of the cation exchange capacity, and most preferably in an amount equal to the cation exchange capacity of the attapulgite clay. The alkoxylated quaternary ammonium salt is preferably present in an amount of greater than about 50% by weight of the total amount of organic cation content. Most preferably, the alkoxylated quaternary ammonium salt is present in an amount from about 50% to 100% by weight of the total amount of organic cation content.

These organophilic clay mixtures have the ability to form a stable gel when mixed with an oil-based drilling fluid base composition to give an oil-based drilling mud that is non-progressive as compared with an otherwise identical oil-based drilling mud having only one type of organophilic clay present in the same proportion as the total organophilic clay mixture. Drilling fluids are said to be progressive gels where the 10-second and 10-minute gel strengths have dissimilar values, with the 10-minute value being much higher than the 10-second value. This result indicates that the gelation of the drilling fluid is rapidly gaining strength with time, which is generally an undesirable feature of a drilling fluid. As a consequence, the drilling fluid may require excessive pump pressures to break circulation. If gels appear to be too progressive, a 30-minute gel strength measurement may be useful as a third check of progress. A “non-progressive” drilling mud would thus be one where the 10-minute gel and the 10 second gel are the same or about the same.

The base composition used in the oil-based drilling muds herein may be any of those typically used, including, but not necessarily limited to, diesel oil, mineral oil, poly(alpha-olefins), propylene glycol, methyl glucoside, modified esters and ethers, and emulsions of oil and water of varying proportions, particularly invert emulsions. Commonly, invert emulsions will contain from about 5 wt % water independently up to about 50 wt % water; alternatively from about 10 wt % water independently up to about 45 wt % water.

The amount of the organophilic clay mixture in the oil-based drilling fluid may range up from about 0.01 wt % independently to about 15 wt %, alternatively from about 0.3% independently to about 5 wt %, and in another non-limiting embodiment from about 0.5 wt % independently to about 3 wt %.

The invention will now be illustrated with respect to certain examples which are not intended to limit the invention in any way but simply to further illustrate it in certain specific embodiments.

### Examples 1-5

A reduced high shear rate reading (600 rpm) is achieved with the composite clay blends. Table I and FIG. 1 show the comparison of a 100 percent modified bentonite formulation with four blends of a 10 percent attapulgite/sepiolite and modified bentonite clays. The modified bentonite clays used were from different sources. The clays in Blends A, B, D and E were from the same supplier, but from different lots. Blends CII and C3 were each modified with different quaternary amines and were from a different supplier than the supplier of the other blends. The modified attapulgite clay used in these Examples was BENTONE® 990 suspension additive available from Elementis Specialties. The primary emulsifier was CARBO-MUL HTa non-ionic emulsifier available from Baker Hughes Incorporated.

Evidently from the results, the pure bentonite clay has a higher shear rate reading (600 rpm) than each of the four blends (see 600 rpm values). The difference grows wider with volume increase of the attapulgite/sepiolite used in the formulation. A significant reduction in high shear rate reading (600 rpm) is achieved with the composite clay blends as a rheological additive. Therefore, operators will experience less pump pressure with the application of these novel blends, an advantage over the traditional use of each individually.

TABLE I
Initial 600 rpm Reading on Composite Clays of
Attapulgite/Sepiolite with Modified Bentonites,
Compared to a 100% Modified Bentonite
12.0 ppg (1.44 kg/L) diesel mud, mixed 11,500 rpm/60 min.

| | | |
|---|---|---|
| Mineral Oil | 169.49 lb/bbl | (483.0 kg/m³) |
| Organophilic | 15 lb/bbl | (42.8 kg/m³) |
| Clay | | |
| Primary | 12 lb/bbl | (34.2 kg/m³) |
| Emulsifier | | |
| Brine | 70.47 lb/bbl | (200.8 kg/m³) |
| (20% CaCl₂) | | |
| Barite (API Grade) | 237.04 lb/bbl | (675.6.0 kg/m³) |
| Total | 504 lb/bbl | (1436 kg/m³) |

| | 100% | Sample ID | | | |
|---|---|---|---|---|---|
| | Modified | Blend | Blend | Blend | Blend |
| | Bentonite | B | C | Cll | C3 |
| Ex. | 1 | 2 | 3 | 4 | 5 |

Before Aging

| | | | | | |
|---|---|---|---|---|---|
| ES | 930 | 865 | 804 | 862 | 930 |
| 600 rpm | 105 | 67 | 74 | 72 | 79 |
| reading | | | | | |
| 300 rpm | 67 | 42 | 48 | 47 | 54 |
| reading | | | | | |
| 200 rpm | 51 | 33 | 38 | 37 | 44 |
| reading | | | | | |
| 100 rpm | 36 | 24 | 28 | 26 | 32 |
| reading | | | | | |
| 6 rpm | 15 | 10 | 11 | 11 | 14 |
| reading | | | | | |
| 3 rpm | 14 | 9 | 10 | 10 | 13 |
| reading | | | | | |
| Gels | 13 & 15 | 9 & 10 | 10 & 11 | 9 & 11 | 11 & 13 |
| (lbs/100 ft²) | (6.2 & | (4.3 & | (4.7 & | (4.3 & | (5.3 & |
| (Pa) | 7.2) | 4.7) | 5.3) | 5.3) | 6.2) |
| PV¹ (cP) | 38 | 25 | 26 | 25 | 25 |
| YP² | 29 | 17 | 22 | 22 | 29 |
| (lbs/100 ft²) | (14) | (8.1) | (10) | (10) | (14) |
| (Pa) | | | | | |

¹plastic viscosity
²yield point

This property is retained after hot rolling the formulations for 16 hours at 275° F. (135° C.) as shown in Table II. The unique 10 percent attapulgite/sepiolite composite clay has a high 6 rpm reading after hot rolling at 275° F. (135° C.) for 16 hours. The blend tolerance to temperature is distinctive, with the ability to sustain the low end rheology as the temperature rises.

TABLE II
After Aging 600 rpm Reading on Composite Clays of
Attapulgite/Sepiolite with Modified Bentonites,
Compared to a 100% Modified Bentonite

| | 100% | Sample ID | | | |
|---|---|---|---|---|---|
| | Modified | Blend | Blend | Blend | Blend |
| | Bentonite | B | C | Cll | C3 |
| Ex. | 1 | 2 | 3 | 4 | 5 |

After Aging

| | | | | | |
|---|---|---|---|---|---|
| ES | 690 | 700 | 702 | 792 | 796 |
| 600 rpm | 86 | 75 | 69 | 70 | 70 |
| reading | | | | | |
| 300 rpm | 54 | 46 | 42 | 43 | 43 |
| reading | | | | | |
| 200 rpm | 42 | 35 | 32 | 34 | 34 |
| reading | | | | | |
| 100 rpm | 30 | 24 | 23 | 24 | 23 |
| reading | | | | | |
| 6 rpm | 11 | 9 | 8 | 9 | 8 |
| reading | | | | | |
| 3 rpm | 10 | 8 | 8 | 8 | 7 |
| reading | | | | | |
| Gels | 10 & 12 | 9 & 10 | 8 & 9 | 9 & 11 | 8 & 10 |
| (lbs/100 ft²) | (4.7 & | (4.3 & | (3.8 & | (4.3 & | (3.8 & |
| (Pa) | 5.7 Pa) | 4.7) | 4.3) | 5.3) | 4.7) |
| PV (cP) | 32 | 29 | 27 | 27 | 27 |
| YP | 22 | 17 | 15 | 16 | 16 |
| (lbs/100 ft²) | (10) | (8.1) | (7.2) | (7.7) | (7.7) |

### Examples 6-10

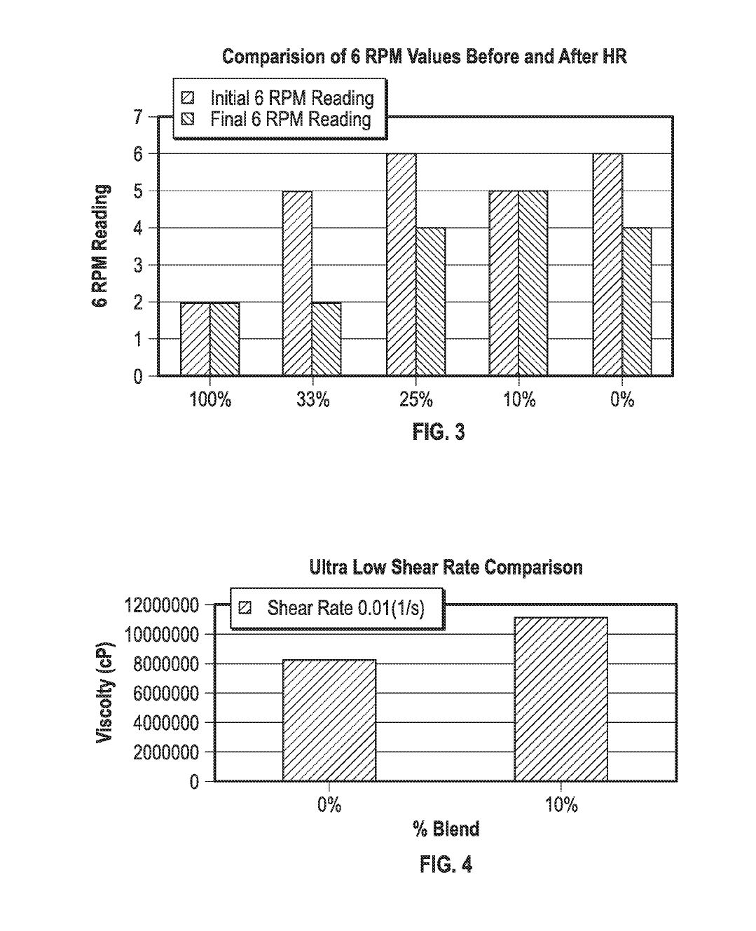

Table III and FIG. 3 summarize this finding. The unique 10 wt % attapulgite/sepiolite composition day has a high 6 rpm reading after hot rolling at 275° F. (135° C.) for 16 hours. The blend tolerance to temperature is distinctive, with the ability to sustain the low end rheology as the temperature rises.

TABLE III
Improved 6 Rpm after Hot Rolling at 275° F. (135° C.)
12.0 ppg (1.44 kg/L) diesel mud, mixed 11,500 rpm/60 min,

| | | |
|---|---|---|
| Diesel | 188 lb/bbl | (535.8 kg/m³) (0 min) |
| Clay Composite Amount | 5 lb/bbl | (14.3 kg/m³) (5 min) |
| Primary Emulsifier | 8 lb/bbl | (22.8 kg/m³) (3 min) |
| Brine (20% CaCl₂) | 72.50 lb/bbl | (206.6 kg/m³) (10 min) |
| Barite (API Grade) | 229 lb/bbl | (652.7 kg/m³) (22 min) |
| Total | 502.5 lb/bbl | (1432 kg/m³) |

Gels

| Ex. | 6 | 7 | 8 | 9 | 10 |
|---|---|---|---|---|---|
| % Attapulgite/ | 100% | 33% | 25% | 10% | 0% |
| Sepiolite Clay | | | | | |

Before Aging

| | | | | | |
|---|---|---|---|---|---|
| Intial 6 rpm reading | 2 | 5 | 6 | 5 | 6 |

After Aging

| | | | | | |
|---|---|---|---|---|---|
| Final 6 rpm reading | 2 | 2 | 4 | 5 | 4 |

An unexpected synergistic effect of the composite clay was evident upon examination. The gels were stable, and less progressive, before and after hot rolling at 275° F. (135° C.), for 16 hours. Tables IV and V, illustrate this unique characteristic, that essentially determines the effectiveness in transportation of cuttings up the annulus.

TABLE IV
Initial Gel Strength of Composite Organophilic Clays
Compared to a 100% Modified Bentonite Clay
12.0 ppg (1.44 kg/L) diesel mud, mixed 11,500 rpm/60 min.

| | | |
|---|---|---|
| Diesel | 188 lb/bbl | (535.8 kg/m³) (0 min) |
| Clay Composite | 5 lb/bbl | (14.3 kg/m³) (5 min) |
| Amount | | |
| Primary Emulsifier | 8 lb/bbl | (22.8 kg/m³) (3 min) |
| Brine (20% CaCl₂) | 72.50 lb/bbl | (206.6 kg/m³) (10 min) |
| Barite (API Grade) | 229 lb/bbl | (652.7 kg/m³) (22 min ) |
| Total | 502.5 lb/bbl | (1376.6 kg/m³) |

Initial Gels

| Ex. | 6 | 7 | 8 | 9 | 10 |
|---|---|---|---|---|---|
| % Attapulgite/ | 100% | 33% | 25% | 10% | 0% |
| Sepiolite Clay | | | | | |
| 10 sec Gel, lb/ | 3.10 | 5.20 | 5.30 | 5.50 | 6.20 |
| 100 ft² (Pa) | (1.48) | (2.49) | (2.58) | (2.63) | (2.97) |
| 10 min Gel, lb/ | 2.80 | 5.40 | 5.90 | 5.90 | 7.30 |
| 100 ft² (Pa) | (1.34) | (2.59) | (2.82) | (2.82) | (3.49) |

TABLE V
Improved Gel Strength of Composite Organophilic
Clays Compared to a Pure Bentonite Clay
12.0 ppg (1.44 kg/L) diesel mud, mixed 11,500 rpm/60 min.

| | | |
|---|---|---|
| Diesel | 188 lb/bbl | (535.8 kg/m³) (0 min) |
| Clay Composite | 5 lb/bbl | (14.3 kg/m³) (5 min) |
| Amount | | |
| Primary Emulsifier | 8 lb/bbl | (22.8 kg/m³) (3 min) |
| Brine (20% CaCl₂) | 72.50 lb/bb | (206.6 kg/m³) (10 min) |
| Barite (API Grade) | 229 lb/bbl | (652.7 kg/m³) (22 min) |
| Total | 502.5 lb/bbl | (1376.0 kg/m³) |

Initial Gels

| Ex. | 6 | 7 | 8 | 9 | 10 |
|---|---|---|---|---|---|
| % Attapulgite/ | 100% | 33% | 25% | 10% | 0% |
| Sepiolite Clay | | | | | |
| 10 sec Gel, | 3 | 1.8 | 4.1 | 4.8 | 3.7 |
| lb/100 ft² (Pa) | (1.43) | (0.86) | (1.96) | (2.30) | (1.77) |
| 10 min Gel | 2.7 | 4.4 | 4.8 | 5.8 | 5.3 |
| lb/100 ft² (Pa) | (1.29) | (2.11) | (2.30) | (2.78) | (2.58) |

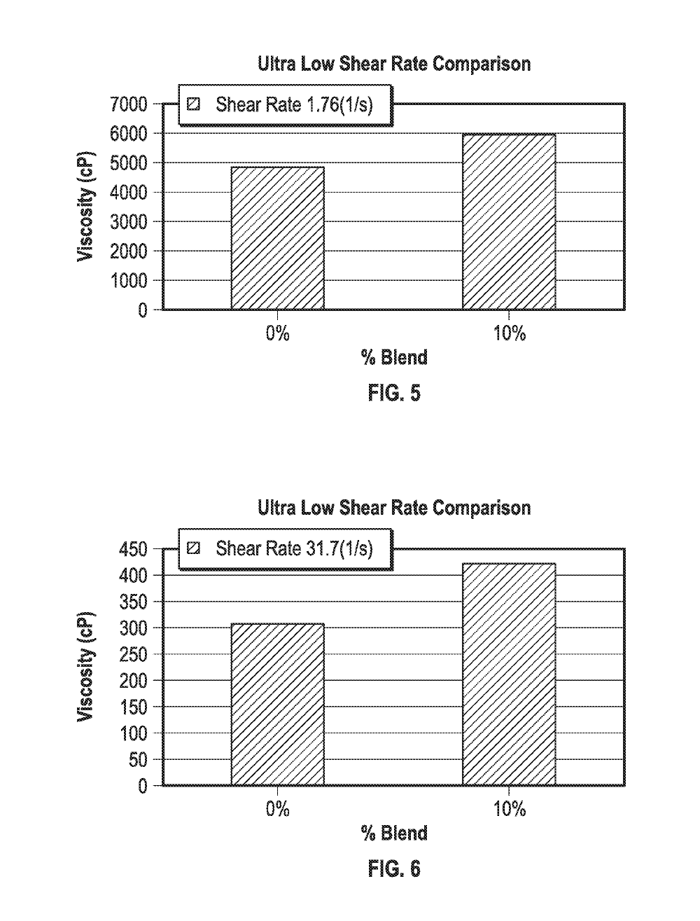

A comparison at ultra-low shear rate viscosity between the 100% modified bentonite and the blended organophilic clays reveals the suspension properties of the latter to be superior. The testing designed to simulate near static conditions or extremely low shear rates demonstrates the ability of the blend composite to suspend cuttings better than the pure bentonite formulation. FIGS. 4, 5, and 6, compare the viscosity of the pure modified bentonite and the blend at ultra low shear rates, from a shear rate of 0.01 (1/s) to a shear rate of 31.7 (1/s). The study results of FIGS. 4, 5 and 6 consistently shows higher viscosity in the 10 percent blend as static conditions are approached. All analyzed formulations are weighted with API grade barite, to increase the density of the fluids to 12 ppg (1.44 kg/L).

A suitable use of the organophilic clay mixtures described herein is applying the composite organophilic clay directly to the base fluid; diesel, paraffins or mineral oils. The added emulsifier stabilizes the system when the aqueous phase is introduced. The application method described is relevant at the lab scale, mud plant and or the rig site. The decline in high shear rate viscosity observed with a simultaneous viscosity increase at ultra-low shear rates, creates good suspension properties with less pumping pressure required for mud circulation. Therefore, the operators will see an advantage in minimal torque and drag while drilling deviated or horizontal sections and savings from pump pressures.

### Examples 11-19

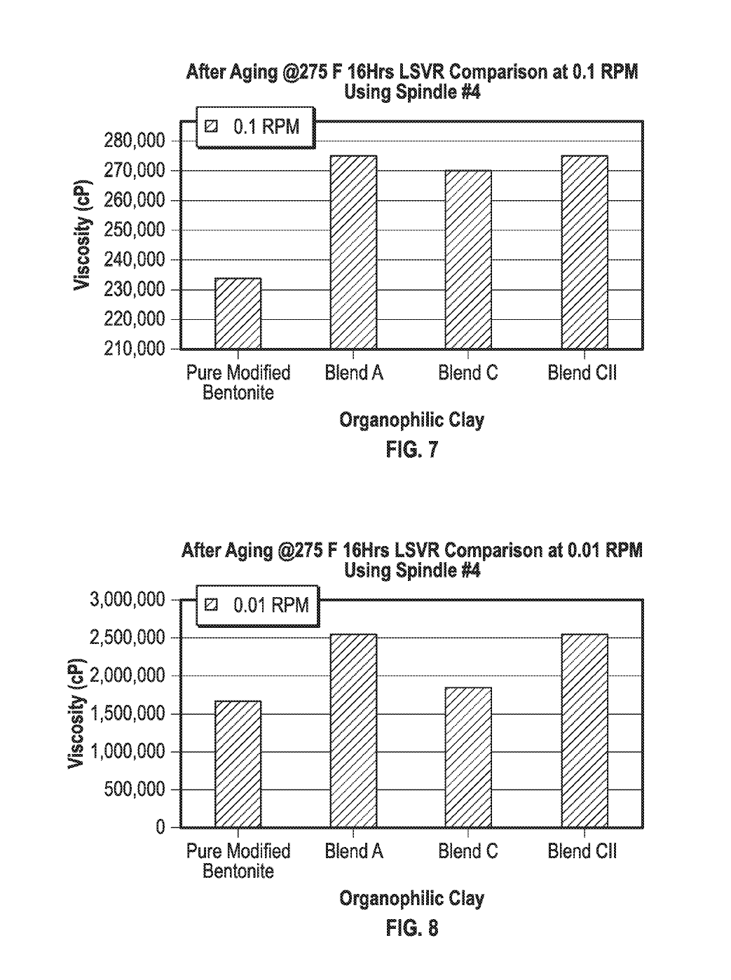

Brookfield Viscometer Testing (Low Shear Viscosity Reading (LSVR)): The blends in Examples 12-14 gave high Brookfield viscosity readings compared to the 100% modified bentonite (Example 11). See Table VI below, and FIG. 7 and FIG. 8. The tool further confirmed the improved ultra-low shear viscosity by the unique blend. All of the blends gave higher viscosities after aging at 275° F. (135° C.) at 0.1 rpm and 0.01 rpm using spindle #4.

TABLE VI
Brookfield Viscometer Testing (LSVR)

| | | 11 | | | |
|---|---|---|---|---|---|
| Ex. | | 100% | | | |
| Organophilic | | Modified | 12 | 13 | 14 |
| Clay | | Bentonite | Blend A | Blend C | Blend Cll |
| 0.1 | rpm | 234,000 | 276,000 | 270,000 | 276,000 |
| 0.01 | rpm | 1,680,000 | 2,580,000 | 1,860,000 | 2,580,000 |

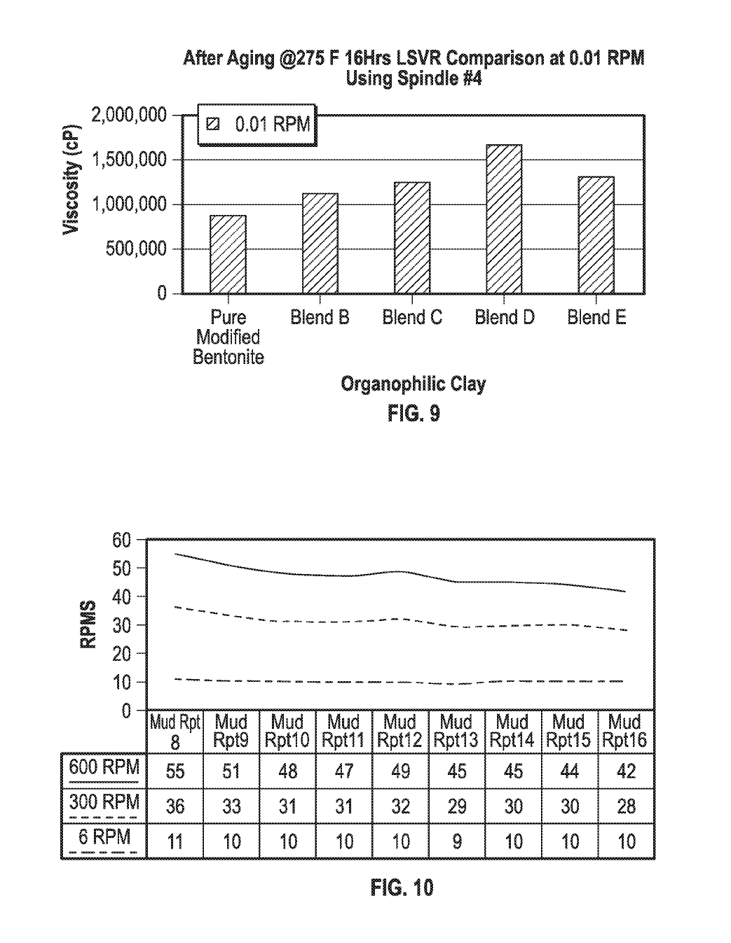

Results from additional testing for the blends of Examples 16-19 compared to the 100% modified bentonite of Example 15 is shown in Table VII and FIG. 9, similar results are shown.

TABLE VI
Brookfield ViscometerTesting (LSVR)

| | 15 | | | | |
|---|---|---|---|---|---|
| Ex. | 100% | | | | |
| Organophilic | Modified | 16 | 17 | 18 | 19 |
| Clay | Bentonite | Blend B | Blend C | Blend D | Blend E |
| 0.01 rpm | 900,000 | 1,140,000 | 1,260,000 | 1,680,000 | 1,320,000 |

### Example 20

### Field Trial of Synergized Clay

A well in northern Texas was drilled using the following two drilling fluids:
MP-HOLD name of synergized organophilic day blend described herein: 10 wt % organophilic attapulgite/sepiolite day blend with 90 wt % modified bentonite.
CARBOGEL II name of 100 wt % modified bentonite clay.

The well was drilled intermediate to 6,568 ft (2,002 m) with WBM low solids non-dispersed drilling mud (LSND) and set 9⅝″ (24.4 cm). The operator displaced a WBM with a CARBO-GEL II OBM used on a previous well. Now from mud report (Rpt) 8 hence forth the CARBO-GEL II OBM was displaced with treatments of MP-HOLD OBM. The interval drilled was from 6,568-12,172 ft-a distance of 5,604 ft (2,002-3,710 m-a distance of 1,708 m). As the well progressed, the concentration of MP-HOLD OBM increased and the legacy CARBO-GEL II OBM decreased.

Total losses for the section were approximately 1160 bbls (184 m³), with about +/−500 bbls (79 m³) (from SCE and +/−600 bbls (95 m³) from seepage, dilution came from diesel (450 bbls (71 m³)), water (300 bbls (48 m³)) and reserve mud (310 bbls (49 m³). Treatments were adjusted accordingly. The King Cobra shakers had 50's or 70's screen sizes to retain volume and the SWACO centrifuge was running 24 hrs to maintain the low 8.6 ppg (1.03 kg/l) mud weight.

FIG. 10 is a chart of the gradual decline of the 600 rpm and the 300 rpm values as MP-HOLD displaced the CARBO-GEL II fluid, and the unchanged 6 RPM.

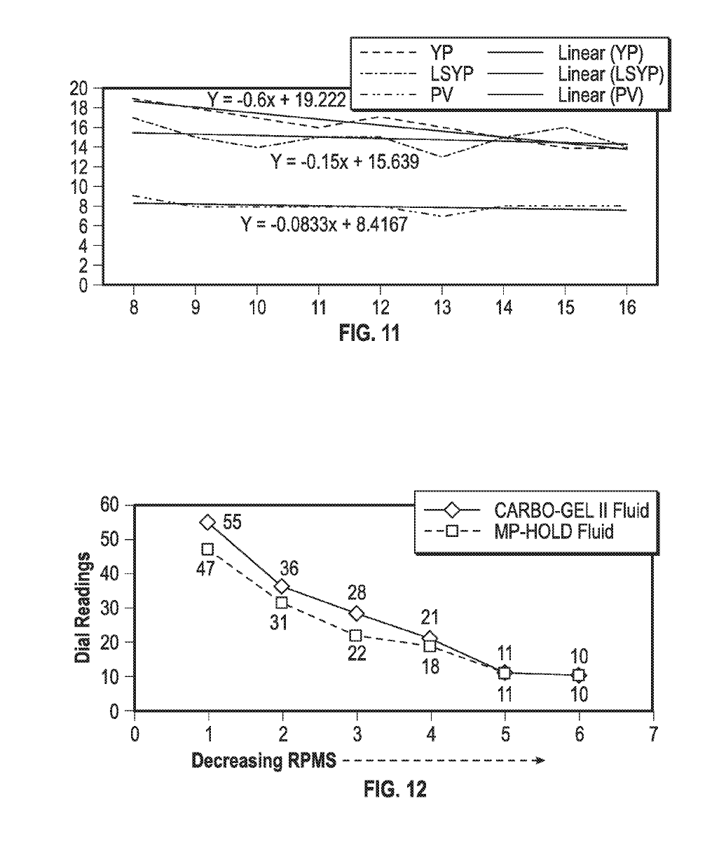

The rheology of the fluid improved with regard to a decreasing plastic viscosity (PV) and the low shear yield point (LSYP or the 3 rpm reading) and the yield point (YP) both maintained little change, as may be seen in FIG. 11. It was also noted that the rheology seen in the laboratory data was observed in the fluid whereby the high end is reduced with no effect on the low end shear, which is very important for hole cleaning.

FIG. 12 shows the comparison of the CARBO-GEL II fluid rheology profile (mud Rpt 8) and the MP-HOLD fluid rheology profile (mud Rpt 17).

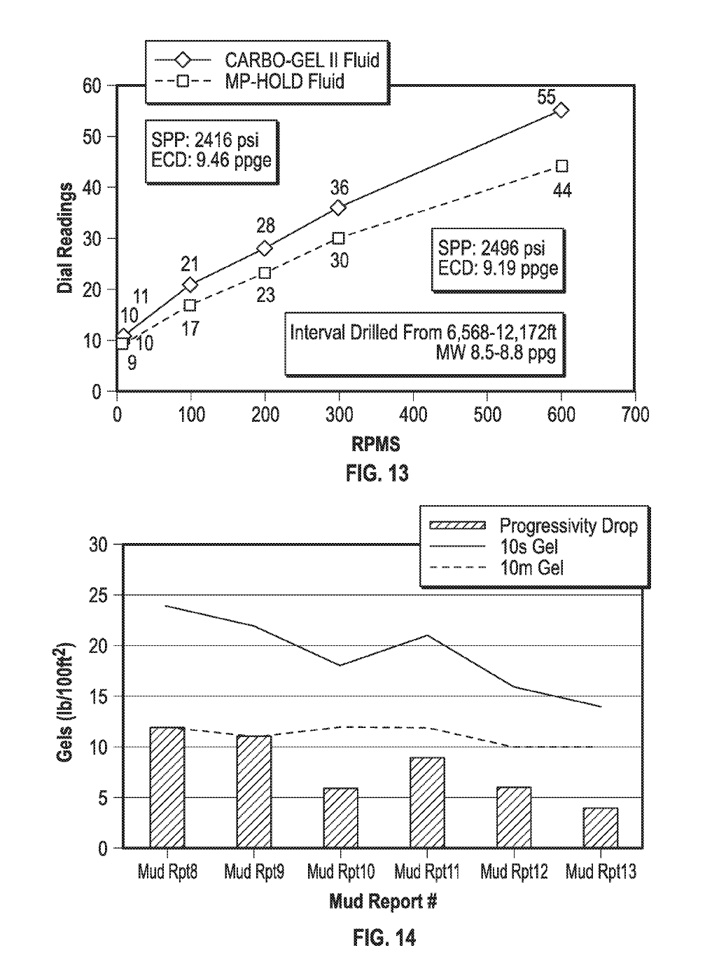

The MP-HOLD fluid had good suspension and hole cleaning properties and it provides lower equivalent circulating densities (ECDs), as demonstrated in FIG. 13. SPP refers to stand pipe pressure. The dial readings are a measure of viscosity at given shear rates from a FANN® 35 standard oil viscometer.

The section was drilled in 10 days which included the 90° curve drilled using LEAM tools (LEAM Drilling Systems LLC). This was at the higher end of the operator's expectations.

The company man noted that the fluid performed without issue and that sliding was faster than on previous wells at about 20 ft (6.1 m)/hr compared to 10-15 ft (3.0-4.6 m)/hr. Rotating in the vertical section was consistently 70-100 ft (21-30 m)/hr. While drilling the vertical section the first 3 days drilled 1317 ft (401 m), 1319 ft (402 m) and 952 ft (290 m) respectively. The operator expected this well to take 35-40 days but this estimate was revised to 30-31 days based on performance.

The driller and directional driller both noted that there was no spike in hook load while picking up, although torque was a little high (variable). Both also confirmed the operators' observation that sliding was easier than on previous wells.

Both the mud engineer and derrickman noted that the products were easy to add (40 lb (18 kg) sacks) and that MP-HOLD appeared to provide better viscosity than CARBO-GEL II used in previous wells.

The 10 sec and 10 min Gels from mud reports 8 to 13 were examined for stability and progressivity. A steady decline in gel progressivity was evident as the MP-HOLD mud dominated the circulating fluid, as shown in Table VII and FIG. 14.

TABLE VII
Decline in Progressivity for Example 20

| Mud Rpt | 10 s Gel | 10 m Gel | Progressivity Drop |
|---|---|---|---|
| Mud Rpt 8 | 12 | 24 | 12 |
| Mud Rpt 9 | 11 | 22 | 11 |
| Mud Rpt 10 | 12 | 18 | 6 |
| Mud Rpt 11 | 12 | 21 | 9 |
| Mud Rpt 12 | 10 | 16 | 6 |
| Mud Rpt 13 | 10 | 14 | 4 |

In the foregoing specification, the invention has been described with reference to specific embodiments thereof, and has been demonstrated as effective in providing clay blend compositions and oil-based muds for drilling wells, particularly deviated wells. However, it will be evident that various modifications and changes can be made thereto without departing from the broader scope of the invention as set forth in the appended claims. Accordingly, the specification is to be regarded in an illustrative rather than a restrictive sense. For example, specific modified attapulgite clays, modified sepiolite clays, modified bentonite clays and oil-base drilling fluid base compositions falling within the claimed parameters, but not specifically identified or tried in a particular composition or method or proportion, are expected to be within the scope of this invention.

The words “comprising” and “comprises” as used throughout the claims is interpreted as “including but not limited to”.

The present invention may suitably comprise, consist of or consist essentially of the elements disclosed and may be practiced in the absence of an element not disclosed. For instance, in one non-limiting embodiment, an organophilic clay mixture may consist essentially of or consist of a first organophilic clay selected from the group consisting of modified attapulgite clay, modified sepiolite clay and combinations thereof, and an organophilic modified bentonite clay: where the days have been modified by treating them with at least one compound selected from the group consisting of quaternary amines, quaternary ammonium salts, and combinations thereof.

Alternatively, there may be provided an oil-based drilling mud consisting essentially of or consisting of an oil-based drilling fluid base composition and an organophilic clay mixture consisting essentially of or consisting of a first organophilic clay selected from the group consisting of modified attapulgite clay, modified sepiolite clay and combinations thereof, and an organophilic modified bentonite day, where the clays have been modified by treating them with at least one compound selected from the group consisting of quaternary amines, quaternary ammonium salts, and combinations thereof

There may be further provided in a non-limiting embodiment, a method for drilling a wellbore through a subterranean formation with an oil-based drilling mud as described above.

1. An organophilic clay mixture comprising:
a first organophilic clay selected from the group consisting of modified attapulgite clay, modified sepiolite clay and combinations thereof, and
an organophilic modified bentonite clay;
where the clays have been modified by treating them with at least one compound selected from the group consisting of quaternary amines, quaternary ammonium salts, and combinations thereof.

2. The organophilic clay mixture of claim 1 where:
the first organophilic clay is present in an amount of from about 5 wt % to about 95 wt %; and
the organophilic modified bentonite clay is present in an amount of from about 95 wt % to about 5 wt %.

3. The organophilic clay mixture of claim 1 where:
the first organophilic clay is present in an amount of from about 10 wt % to about 90 wt %; and
the organophilic modified bentonite clay is present in an amount of from about 90 wt % to about 10 wt %.

4. The organophilic clay mixture of claim 1 where the first organophilic clay is a modified attapulgite clay present in an amount of about 10 wt % and the organophilic modified bentonite clay is present in an amount of about 90 wt %.

5. The organophilic clay mixture of claim 1 where the mixture has the ability to form a stable gel when mixed with an oil-based drilling fluid base composition to give an oil-based drilling mud that is non-progressive as compared with an otherwise identical oil-based drilling mud having only one type of organophilic clay present in the same proportion as the organophilic clay mixture.

6. An oil-based drilling mud comprising:
an oil-based drilling fluid base composition; and
an organophilic clay mixture comprising:
a first organophilic clay selected from the group consisting of modified attapulgite clay, modified sepiolite clay and combinations thereof, and
an organophilic modified bentonite clay;
where the clays have been modified by treating them with at least one compound selected from the group consisting of quaternary amines, quaternary ammonium salts, and combinations thereof.

7. The oil-based drilling mud of claim 6 where the amount of organophilic clay mixture in the oil-based drilling mud is about 3 wt % or less.

8. The oil-based drilling mud of claim 6 where in the organophilic clay mixture:
the first organophilic clay is present in an amount of from about 5 wt % to about 95 wt %; and
the organophilic modified bentonite clay is present in an amount of from about 95 wt % to about 5 wt %.

9. The oil-based drilling mud of claim 6 where in the organophilic clay mixture:
the first organophilic clay is present in an amount of from about 10 wt % to about 90 wt %; and
the organophilic modified bentonite clay is present in an amount of from about 90 wt % to about 10 wt %.

10. The oil-based drilling mud of claim 6 where the oil-based drilling mud forms a stable gel that is non-progressive as compared with an otherwise identical oil-based drilling mud having only one type of organophilic clay present in the same proportion as the organophilic clay mixture.

11. A method of drilling a wellbore through a subterranean formation with an oil-based drilling mud comprising:
an oil-based drilling fluid base composition; and
an organophilic clay mixture comprising:
a first organophilic clay selected from the group consisting of modified attapulgite clay, modified sepiolite clay and combinations thereof, and
an organophilic modified bentonite clay;
where the clays have been modified by treating them with at least one compound selected from the group consisting of quaternary amines, quaternary ammonium salts, and combinations thereof.

12. The method of claim 11 where the amount of organophilic clay mixture in the oil-based drilling mud is about 3 wt % or less.

13. The method of claim 11 where in the organophilic clay mixture:
the first organophilic clay is present in an amount of from about 5 wt % to about 95 wt %; and
the organophilic modified bentonite clay is present in an amount of from about 95 wt % to about 5 wt %.

14. The method of claim 11 where in the organophilic clay mixture:
the first organophilic clay is present in an amount of from about 10 wt % to about 90 wt %; and
the organophilic modified bentonite clay is present in an amount of from about 90 wt % to about 10 wt %.

15. The method of claim 11 where the oil-based drilling mud forms a stable gel that is non-progressive as compared with an otherwise identical oil-based drilling mud having only one type of organophilic clay present in the same proportion as the organophilic clay mixture.

16. The method of claim 11 where the wellbore is a deviated wellbore.
